(19) United States
(12) Patent Application Publication
(10) Pub. No.: US 2025/0388148 A1
(43) Pub. Date: Dec. 25, 2025

(54) BACK FRAME

(71) Applicant: TOYOTA BOSHOKU KABUSHIKI KAISHA, Aichi (JP)

(72) Inventors: Yushi SHINOZAKI, Aichi (JP); Yuya AKAI, Aichi (JP); Taiichiro GOTO, Aichi (JP)

(73) Assignee: TOYOTA BOSHOKU KABUSHIKI KAISHA, Aichi (JP)

(21) Appl. No.: 19/241,788

(22) Filed: Jun. 18, 2025

(30) Foreign Application Priority Data
Jun. 21, 2024 (JP) 2024-100261

(51) Int. Cl. B60N 2/68

(52) U.S. Cl. CPC B60N 2/682

(57) ABSTRACT

To provide a back frame of a vehicle seat. A back frame of the present disclosure includes a frame-shaped frame, a support wire for supporting a back of a sitter, and a wire holding portion provided on the frame and holding the support wire at a position shifted from an end portion in an extending direction of the support wire. The end portion in the extending direction of the support wire is located inside the frame, and a space in which the support wire can be disposed is provided on an extension line of the end portion in the extending direction inside the frame.

### CROSS-REFERENCE TO RELATED APPLICATIONS

The present application claims priority based on Japanese Patent Application No. 2024-100261 filed to Japanese Patent Office on Jun. 21, 2024, and the content of Japanese Patent Application No. 2024-100261 is incorporated by reference in its entirety.

### BACKGROUND

The present disclosure relates to a back frame of a vehicle seat.

As described in, for example, Japanese Unexamined Patent Application Publication No. 2022-167380, a back frame of a vehicle seat includes at least a frame-shaped frame and a support member for supporting the back of a sitter.

### SUMMARY

The present disclosure discloses an example of a back frame in which a common support member can be used even in a case where the dimension of a frame is different for each vehicle type.

A back frame of a vehicle seat desirably includes, for example, at least one of the following components.

The components include a frame-shaped frame, a support wire for supporting a back of a sitter, and a wire holding portion provided on the frame and holding the support wire at a position shifted from an end portion in an extending direction of the support wire.

Desirably, the end portion in the extending direction of the support wire is located inside the frame, and a space in which the support wire can be disposed is provided on an extension line of the end portion in the extending direction inside the frame.

“Inside the frame” refers to a space surrounded by the inner walls of the frame on at least two sides. Desirably, “inside the frame” refers to a space in which the seat longitudinal direction and the upper side are surrounded by the inner walls of the frame.

As a result, even in a case where the dimension of the frame is different for each vehicle type and thus the position of the end portion in the extending direction of the support wire varies, the positional difference can be absorbed. Therefore, the common support wire can be used even in a case where the dimension of the frame is different for each vehicle type.

The back frame may have the following configuration. Desirably, the frame includes at least a first side frame extending in a vertical direction, a second side frame disposed at a position shifted from the first side frame in a seat width direction, the second side frame extending in a vertical direction, and an upper frame extending in the seat width direction and connecting an upper end side of the first side frame and an upper end side of the second side frame, the upper frame includes an upper wall portion and a lower wall portion opposing each other in a state of being separated from each other in the vertical direction, and has a substantially C-shaped cross-sectional shape with one side in a seat longitudinal direction opened, and a wire holding portion is provided on the lower wall portion, and a cut-out recessed portion forming the space is provided in the upper wall portion.

### BRIEF DESCRIPTION OF THE DRAWINGS

An example embodiment of the present disclosure will be described below with reference to the accompanying drawings, in which:

FIG. 1 is a diagram illustrating a back frame;

FIG. 2 is an exploded diagram of a joint portion of a first side frame and an upper frame;

FIG. 3 is a diagram illustrating the joint portion of the first side frame and the upper frame; and

FIG. 4 is a diagram illustrating the relationship between the upper frame and a support wire.

### DETAILED DESCRIPTION OF EXEMPLARY EMBODIMENTS

The following “embodiments of the present invention” illustrate examples of embodiments falling within the technical scope of the present disclosure. That is, the matters specifying the invention and the like described in the claims are not limited to the specific configurations, structures and the like described in the following embodiments.

The present embodiment is an example of a back frame of a seat (hereinafter, referred to as vehicle seat) mounted on a vehicle such as an automobile. Arrows indicating directions, oblique lines, and the like attached to the individual drawings are described in order to facilitate understanding of the relationship between the individual drawings, the shape of members or portions, and the like.

The back frame is not limited to the directions illustrated in the drawings. The directions illustrated in the individual drawings are directions in a state where the vehicle seat is assembled to a vehicle. The view with oblique lines does not necessarily show a cross-sectional view.

At least one member or portion described with at least a reference sign is provided unless otherwise noted such as “only one”. That is, when there is no description such as “only one”, two or more members may be provided. The back frame disclosed in the present disclosure includes at least one of components such as members or portions described with at least reference signs and structural portions shown in the drawings.

### First Embodiment

### <1. Outline of Back Frame>

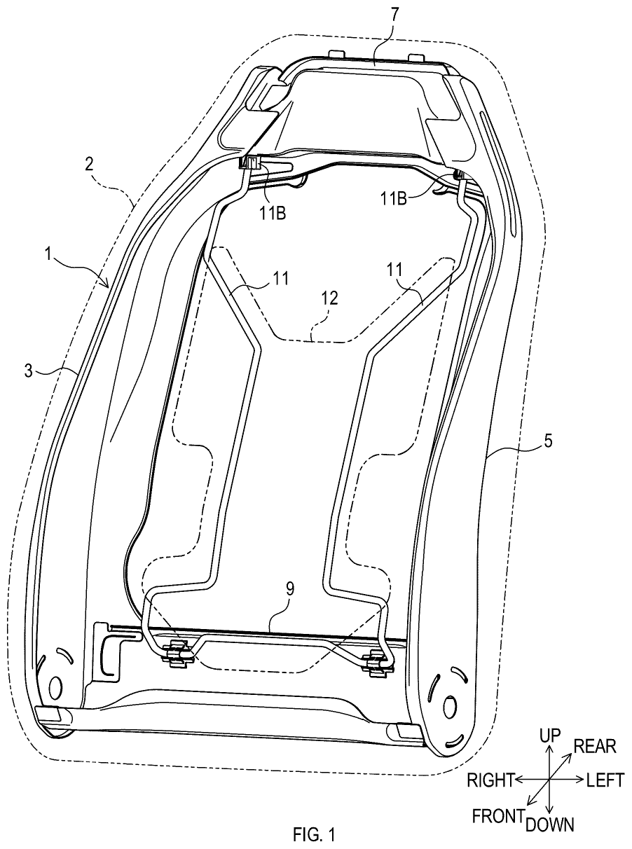

As illustrated in FIG. 1, a back frame 1 is a substantially rectangular frame-shaped frame constituting the framework of a seat back 2. The seat back 2 is a portion for supporting the back of a sitter.

The back frame 1 includes a first side frame 3, a second side frame 5, an upper frame 7, a lower frame 9, and a support wire 11. The back frame 1 includes a plurality of support wires 11.

The first side frame 3 and the second side frame 5 are strength members extending substantially in the vertical direction. The second side frame 5 is disposed at a position shifted from the first side frame 3 in a seat width direction (in FIG. 1, to the left side).

The upper frame 7 is a strength member extending in the seat width direction and connecting the upper end side of the first side frame 3 and the upper end side of the second side frame 5. The lower frame 9 is a strength member extending in the seat width direction and connecting the lower end side of the first side frame 3 and the lower end side of the second side frame 5.

The first side frame 3, the second side frame 5, the upper frame 7, and the lower frame 9 are made of metal, and the frames are joined by laser welding. The first side frame 3, the second side frame 5, the upper frame 7, the lower frame 9, and the like constitute the rectangular frame-shaped frame.

The two support wires 11 are members for supporting the back of the sitter. The support wire 11 on the right side and the support wire 11 on the left side are line-symmetric with respect to a virtual vertical line passing through the center in the seat width direction.

A lumbar plate 12 indicated by a two-dot chain line is attached to the two support wires 11. That is, the two support wires 11 support the back of the sitter via the lumbar plate 12.

The two support wires 11 are connected to each other at the vicinity of the lower frame 9. That is, the two support wires 11 are formed by molding one metal wire into a predetermined shape.

### <2. Structure of Fixing Support Wire to Frame>

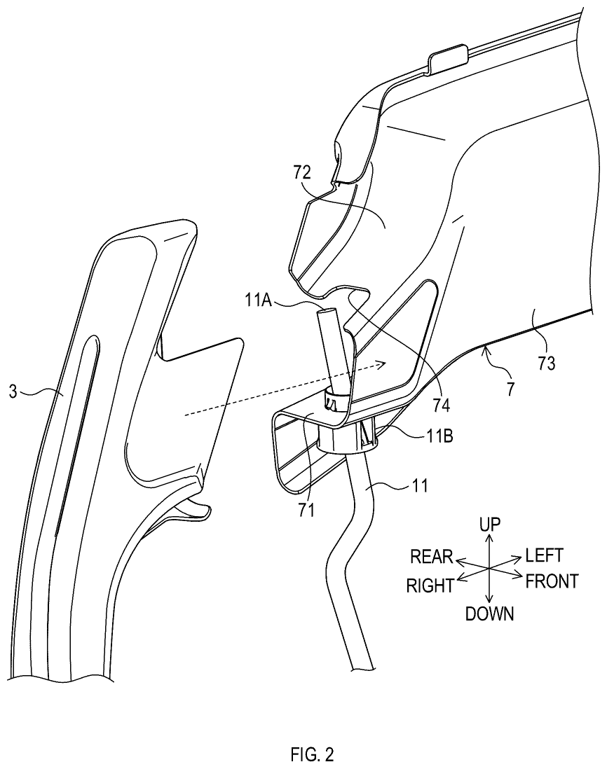

As illustrated in FIG. 2, an upper end portion 11A of each support wire 11 is located inside the frame. Specifically, the upper end portion 11A is located inside a coupling portion of the first side frame 3 and the upper frame 7.

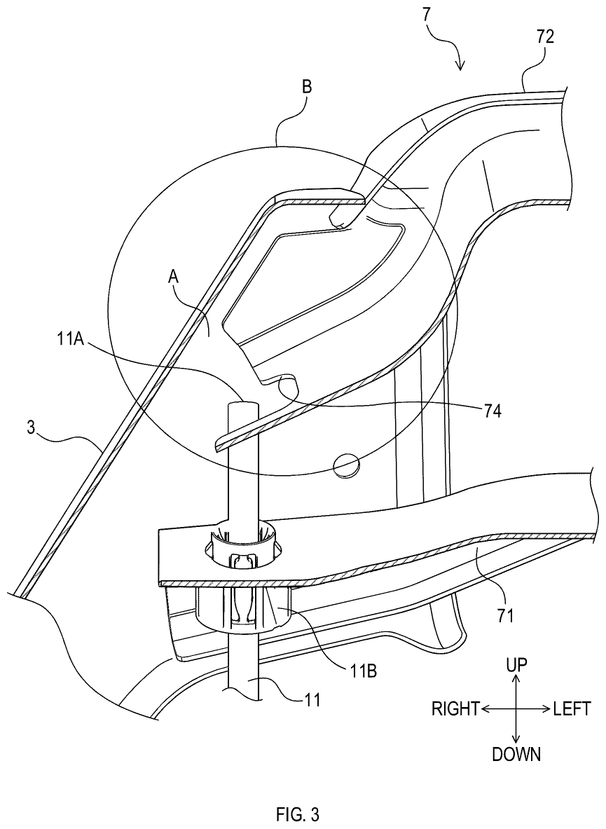

The coupling portion refers to a portion in which the first side frame 3 and the upper frame 7 are coupled, and the inside of the coupling portion refers to a region surrounded by the first side frame 3 and the upper frame 7 on at least three sides. As illustrated in FIG. 3, a space A in which the support wire 11 can be disposed is provided on an extension line of the upper end portion 11A in a coupling portion B.

Specifically, even if the position of the upper end portion 11A is above the position illustrated in FIG. 3 in the coupling portion B, there is no portion or member that interferes with the upper end portion 11A.

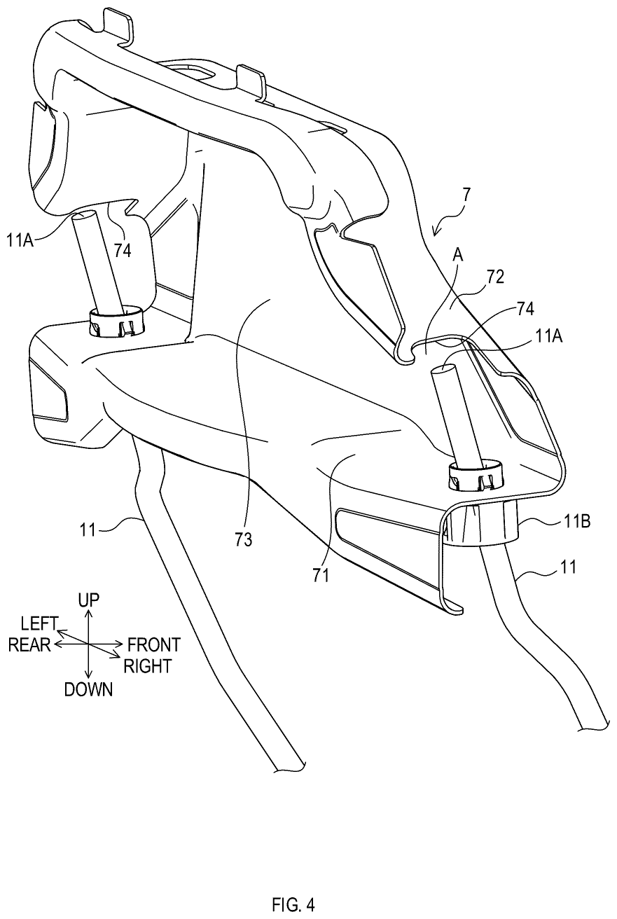

As illustrated in FIG. 4, the upper frame 7 has a substantially C-shaped cross-sectional shape with one side (in the present embodiment, the rear side) in the seat longitudinal direction opened. Specifically, the upper frame 7 includes a lower wall portion 71, an upper wall portion 72, a front wall portion 73, and the like.

The lower wall portion 71 and the upper wall portion 72 oppose each other in a state of being separated from each other in the vertical direction. The front wall portion 73 closes the front side so as to connect the front end side of the lower wall portion 71 and the front end side of the upper wall portion 72.

The lower wall portion 71, the upper wall portion 72, and the front wall portion 73 are integrally molded by applying plastic working such as press working to one steel plate. A wire holding portion 11B is provided at a position shifted downward from the upper end portion 11A of the support wire 11.

The wire holding portion 11B is a grommet holding member made of resin that holds the support wire 11. The wire holding portion 11B is attached to the lower wall portion 71. A cut-out recessed portion 74 forming the space A is provided in the upper wall portion 72.

As illustrated in FIG. 1, each of the lower end sides of the two support wires 11 includes a portion extending in the seat width direction. The portion is rotatably coupled to the lower frame 9.

### <3. Characteristics of Back Frame>

In the back frame 1, the upper end portion 11A of the support wire 11 is located in the coupling portion B, and the space A in which the support wire 11 can be disposed is provided on an extension line of the upper end portion 11A in the coupling portion B.

As a result, even in a case where the dimension of the back frame 1 is different for each vehicle type and thus the position of the upper end portion 11A of each support wire 11 varies, the positional difference can be absorbed. Therefore, the common support wire 11 can be used even in a case where the dimension of the back frame 1 is different for each vehicle type, and thus robustness is improved.

### OTHER EMBODIMENTS

The above embodiment has described the upper end portion 11A of the support wire 11. However, the present disclosure is not limited thereto. For example, the present disclosure is also applicable to a lower end portion of the support wire 11.

In the embodiment described above, the support wire 11 extends in the vertical direction. However, the present disclosure is not limited thereto. For example, the present disclosure is also applicable to a configuration in which the support wire 11 extends in the seat width direction.

In the embodiment described above, the space A is formed by the cut-out recessed portion 74. However, the present disclosure is not limited thereto. For example, the space A may be formed by eliminating the cut-out recessed portion 74 and making the dimension in the seat width direction of the upper wall portion 72 smaller than the dimension in the seat width direction of the lower wall portion 71.

The upper frame 7 according to the embodiment described above has a substantially C-shaped cross-sectional shape with the rear side opened. However, the present disclosure is not limited thereto. For example, it may have a substantially C-shaped cross-sectional shape with the front side opened or a closed cross-sectional shape.

In the embodiment described above, the lumbar plate 12 is attached to the two support wires 11. However, the present disclosure is not limited thereto. For example, the lumbar plate 12 may be eliminated.

In the embodiment described above, the vehicle seat according to the present disclosure is applied to a vehicle. However, the application of the invention disclosed herein is not limited thereto. For example, the present invention can also be applied to seats used for vehicles such as railway vehicles, ships, and aircrafts, and stationary seats used in theaters, homes, and the like.

Furthermore, the present disclosure is not limited to the embodiments described above as long as it meets the gist of the disclosure described in the embodiments. Therefore, a configuration in which at least two of the plurality of embodiments described above are combined, or a configuration in which any of the components illustrated in the drawings or the components described with reference signs in the embodiments is eliminated may be used.

What is claimed is:

1. A back frame of a vehicle seat comprising:
a frame-shaped frame;
a support wire for supporting a back of a sitter; and
a wire holding portion provided on the frame and holding the support wire at a position shifted from an end portion in an extending direction of the support wire, wherein
the end portion in the extending direction of the support wire is located inside the frame, and
a space in which the support wire can be disposed is provided on an extension line of the end portion in the extending direction inside the frame.

2. The back frame according to claim 1, wherein the frame includes
a first side frame extending in a vertical direction,
a second side frame disposed at a position shifted from the first side frame in a seat width direction, the second side frame extending in a vertical direction, and
an upper frame extending in the seat width direction and connecting an upper end side of the first side frame and an upper end side of the second side frame,
the upper frame includes an upper wall portion and a lower wall portion opposing each other in a state of being separated from each other in the vertical direction, and has a substantially C-shaped cross-sectional shape with one side in a seat longitudinal direction opened, and
a wire holding portion is provided on the lower wall portion, and a cut-out recessed portion forming the space is provided in the upper wall portion.
